(19) United States
(12) Patent Application Publication
(10) Pub. No.: US 2002/0192323 A1
(43) Pub. Date: Dec. 19, 2002

(54) INJECTION MOLDING APPARATUS FOR A NON-METALLIC INJECTION MOLD

(76) Inventors: CARL E. RADZIO JR., BROCKPORT, NY (US); RICHARD C. BENSON, ROCHESTER, NY (US); ROBYN S. CHADDOCK, ELBA, NY (US)

Correspondence Address: PATENT LEGAL STAFF, EASTMAN KODAK COMPANY, 343 STATE STREET, ROCHESTER, NY, 14650-2201, US

(21) Appl. No.: 09/452,930

(22) Filed: Dec. 2, 1999

(51) Int. Cl. B29C 45/84

(52) U.S. Cl. 425/149; 425/151; 425/577; 425/812

(57) ABSTRACT

An injection molding apparatus has a non-metallic injection mold and a pressure relief valve for handling excess resin pressure in the cavity mold. The pressure relief valve responds to excess resin pressure in the hollow by providing an alternate resin passage for the pressurized excess resin.

### CROSS-REFERENCE TO RELATED APPLICATIONS

The present application is related to U.S. application Ser. No. (Docket 80027), filed herewith, by Radzio, et al., and entitled, “Pressure Relief Valve For Non-Metallic Injection Molds,” and U.S. application Ser. No. (Docket 80028), filed herewith, by Radzio, et al., and entitled, “Method of Releasing Pressure In Non-Metallic Injection Molds.”

### FIELD OF THE INVENTION

The invention relates generally to the field of injection molding. More particularly, the invention concerns an injection molding apparatus having a pressure relief valve that provides an alternate resin passage for excess molten resin under a predetermined pressure in a non- metallic injection mold.

### BACKGROUND OF THE INVENTION

Cost reductions in low to mid volume injection molding operations has led to the use of one piece case epoxy molds as an alternative to more expensive steel or aluminum tooling. Several have developed techniques to produce production injection molded parts using these cast epoxy molds. The epoxy molds are cast as a single piece for each half of the mold as opposed to hard tooling that is machined out of steel or aluminum. The main limiting factor of the epoxy mold is its inability to withstand the normal cavity pressures created within a conventional mold. Epoxy molds will only tolerate 10%-15% of the pressure that a steel or aluminum mold will tolerate. But they still require adequate pressure during injection and packing to produce an acceptable part. If cavity pressure should spike during injection or pack, the epoxy mold will fail catastrophically. This means that one half, or in some cases both halves, of the mold will split into pieces, effectively destroying the mold.

It is our experience that epoxy injection molds for molding low to mid volume production parts need protection against catastrophic failure. The method and apparatus for protecting these molds needs to be simple, adjustable for different molding resins, specific to each mold so that the mold is protected in any molding machine, and the method and apparatus needs to reset itself automatically whenever it is actuated to protect the mold. Several known attempts have been made to resolve these problems unique to non-metallic molds but most were rejected because of cost and the problem of modifying all the different molding machines that these molds can run in.

In U.S. Pat. No. 5,350,288, Sep. 27, 1994, by Kimoto et al., entitled Injection Molding Unit, an injection molding unit is disclosed that uses a pressure relief valve in a conventional metallic (steel) mold. A major shortcoming of the aforementioned valve arrangement is that if the relief valve operates and releases excess melt pressure from the mold, the mold and/or relief valve assembly will have to be disassembled to remove the solidified plastic material. Moreover, the relief valve operates as a part of the injection molding machine without any obvious means of adjusting the pressure.

Therefore, a need persists in the art for an injection molding apparatus having a non-metallic mold that resists catastrophic failure under high molten resin pressure.

### SUMMARY OF THE INVENTION

An object of the present invention is to provide an injection molding apparatus having a non-metallic injection mold for molding low to medium volume production parts without catastrophic failures.

Another object of the invention is to provide an injection molding apparatus that provides an adjustable pressure relief valve that can be set at a predetermined value for accommodating molten resins having different flow characteristics.

It is another object of the invention to provide an injection molding apparatus that has an alternate flow path for accommodating excess molten resin produced by excess resin pressure.

It is a feature of the invention that a pressure relief valve associated with the molding apparatus provides the molten resin access to the alternate molten resin flow passage when the pressure in the molten resin passage is beyond a predetermined value.

To achieve one or more of the above objects, features and advantages of the invention, there is provided in one aspect of the invention, an injection molding apparatus having an injection molding machine for injecting molten resin into a mold cavity. The injection molding machine includes a screw cylinder having a tip, a nozzle at the tip and a screw advanceable in the screw cylinder for injecting molten resin from the nozzle. A non-metallic injection mold for receiving the molten resin comprises a cavity mold and a core mold forming a hollow therebetween for forming an injection molded product therein. A molten resin passage extends from inside the screw cylinder to a terminal end of the hollow. A pressure relief valve located on the resin passage at the terminal end of the hollow is adapted to release the molten resin from the resin passage at a pressure of the molten resin in the resin passage greater than a predetermined value.

The apparatus of the invention, therefore, has numerous advantageous effects over currently existing developments, including: parts can be molded in an epoxy injection mold without the prospects of mold failure; the pressure relief valve is adjustable for different resins (for instance PC requires a heavier spring and less adjustment pre-load than HIPS); the pressure relief valve is specific to the mold, i.e., once it is set up properly and adjusted for a specific resin, it operates to protect the mold in any molding machine that one might use; the pressure relief valve resets itself automatically after it actuates; and, any part molded when the pressure relief valve actuates will eject from the mold with the resin from the escape channel attached.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is a cross-section view of a typical injection molding machine;

FIG. 2 is a cross section of the injection molding apparatus of the invention having the pressure relief valve in a molten resin blocking position; and

FIG. 3 is a cross-section of the injection molding apparatus of the invention having the pressure relief valve in a molten resin unblocking position.

### DETAILED DESCRIPTION OF THE INVENTION

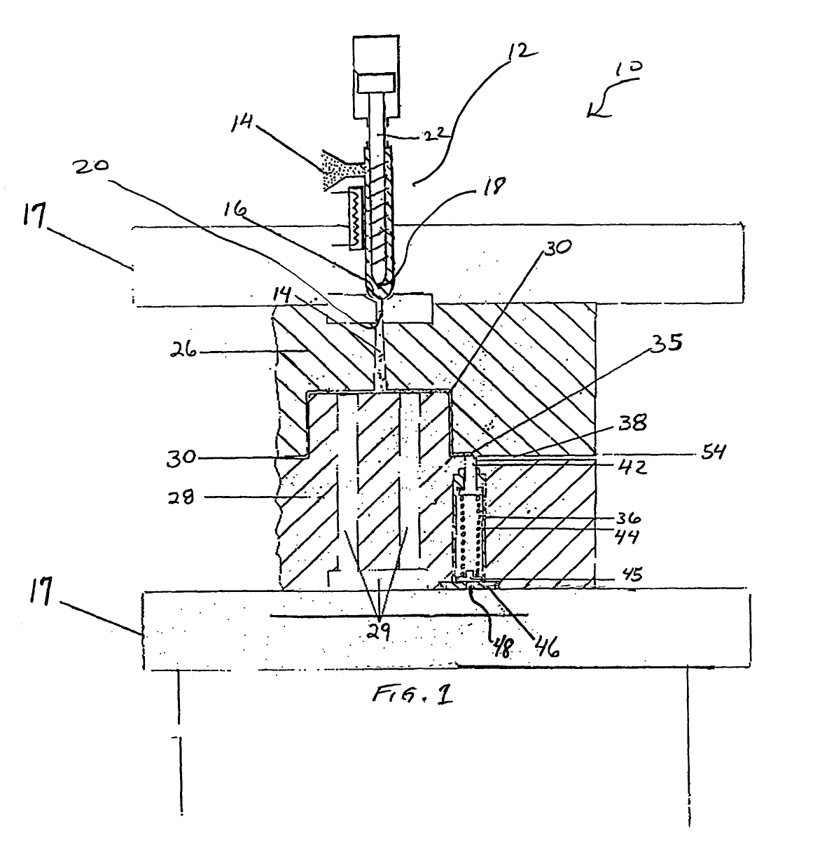

Turning now to the drawings, and in particular to FIGS. 1-3, an injection molding apparatus 10 is illustrated. Broadly defined, according to FIG. 1, injection molding apparatus 10 has an injection molding machine 12 for injecting molten resin 14. Skilled artisans will appreciate that injection molding machine 12 has a platen 17, supporting a screw cylinder 16 having a tip 18, a nozzle 20 at the tip 18 and a screw 22 advanceable in the screw cylinder 16 for injecting molten resin 14 from the nozzle 20.

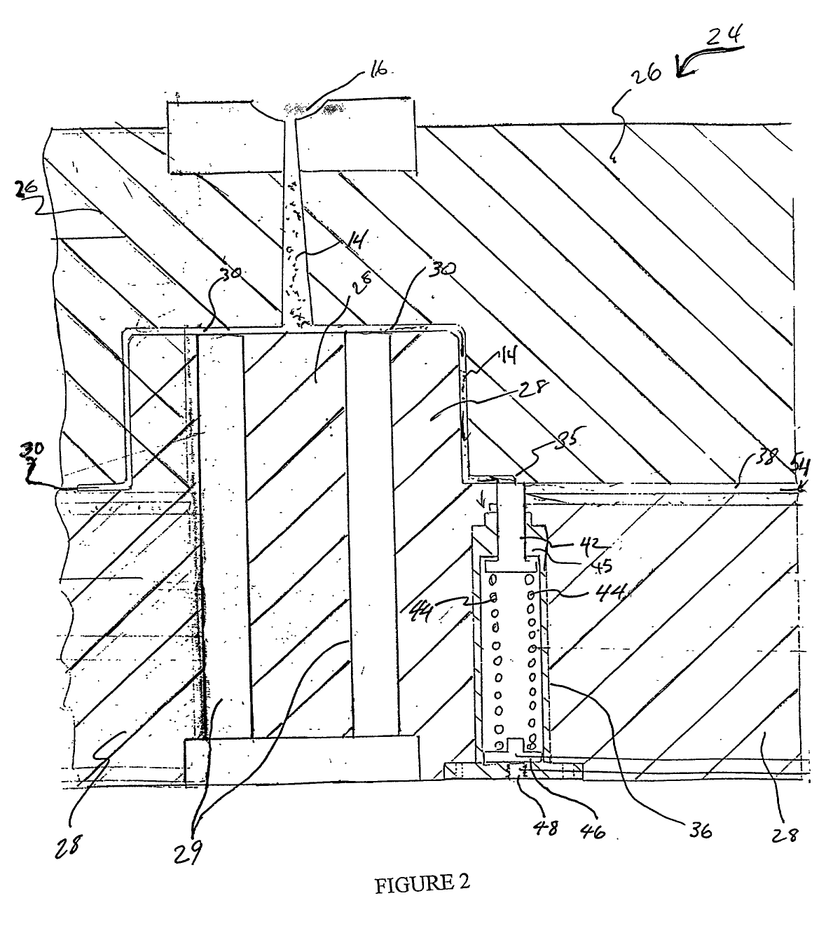

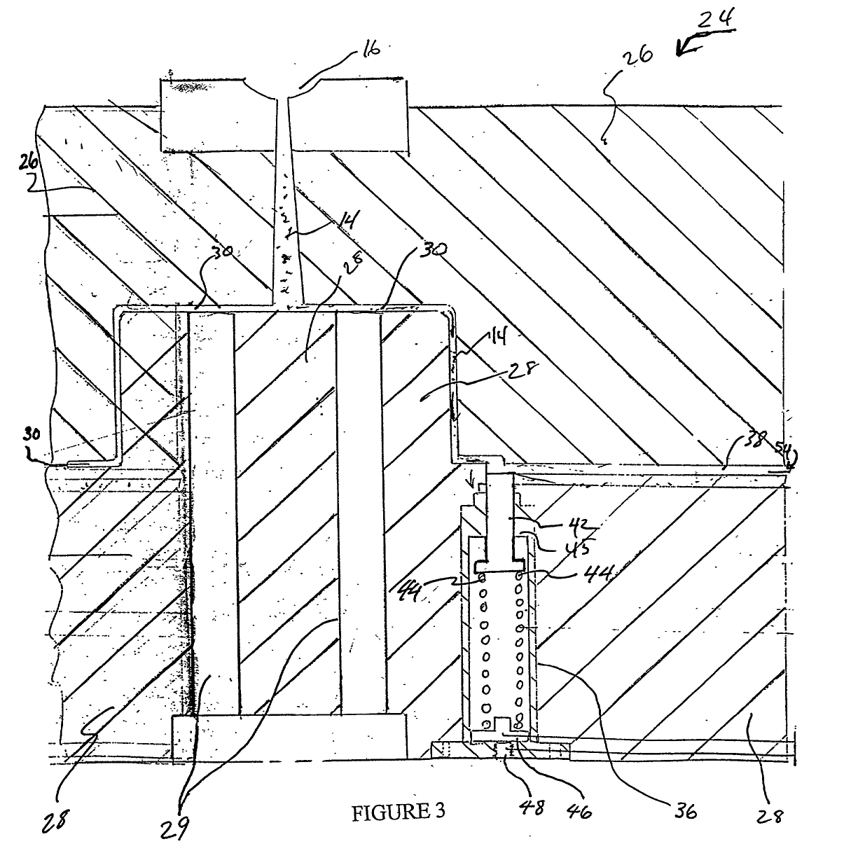

According to FIGS. 2-3, the injection molding apparatus 10 of the present invention has a non-metallic injection mold 24 for molding a part (not shown). Non-metallic injection mold 24 comprises a stationary cavity mold 26 and a movable core mold 28 forming a hollow or first molten resin flow path 30 therebetween for forming an injection molded product therein. Core mold 28 is movable by ejector pins 29 arranged in mold 24 for forceably separating the hollow 30 from the core mold 28. Non-metallic injection mold 24 may include various materials such as thermoset materials as well as cast epoxy, stereo lithography urethane and silicone. In the preferred embodiment, the injection mold 24 is constructed of cast epoxy.

Referring to FIG. 2, hollow or first molten resin flow path 30 extends from the screw cylinder 16 to a terminal end 35 of the hollow 30. A pressure relief valve 36 is located on the hollow or first molten resin flow path 30 at the terminal end 35 of the hollow 30. Pressure relief valve 36 is adapted to release the molten resin 14 from the first molten resin flow path 30 when the pressure of the molten resin 14 exceeds a predetermined level or value, further discussed below.

In FIG. 2, more particularly, pressure relief valve 36 is shown in a first position blocking molten resin flow beyond the terminal end 35 of the first molten resin flow path 30. In this position, molten resin 14 is retained in the hollow or first molten resin flow path 30 by the pressure of movable pin 42. The pressure of the molten resin 14 in this position is generally less than a predetermined value determined by the strength of a spring bias 44 (described below) biasing movable pin 42.

Referring to FIG. 3, pressure relief valve 36 is shown in a second position unblocking the excess molten resin 14 in the hollow or first molten resin flow path 30 thereby enabling the excess molten resin 14 to flow into a second molten resin flow path 38 beyond the first molten resin flow path 30. In this configuration, the first molten resin flow path or hollow 30 is in fluid communications with the second molten resin flow path 38. As depicted in FIGS. 2-3, the pressure relief valve 36 has preferably a cylindrically shaped body with a movable pin 42 arranged for axial movements in one end 45. A spring bias 44 is disposed between the movable pin 42 and a base plate 46 that affixes the spring bias 44 under the movable pin 42 in a biasing relations. In the preferred embodiment, an adjustment screw 48 is arranged in the base plate 46 for applying the pre-load to the spring bias 44. Preferably, the entire pressure relief valve 36 is cast into the movable core mold 28 of an epoxy injection mold so that the movable pin 42 extends through the parting line 54 to shut off the second molten resin flow path 38. The novel and unobvious design of the second molten resin flow path 38 on the surface of the parting line 54 allows the vented molten resin 14 to come out of the mold 24 with the part and then allows the pressure relief valve 36 to reset automatically. Skilled artisans will appreciate that pressure relief valve 36 may also be cast in the stationary cavity mold 26 of the mold 24.

Referring to FIGS. 2-3, pressure relief valve 36 for epoxy injection molds 24 is adjustable by one of two ways. First, the adjustment screw 48 may be adjusted to apply more or less resistance on spring bias 44. Second, the spring bias 44 may be selected having a pre-selected strength, as discussed further below. Although either means of adjusting pressure relief valve 36 has advantages over the other, we generally prefer adjusting the adjustment screw 48 to affect the resistance of the spring bias 44 that governs the movements of movable pin 42.

Referring again to FIGS. 2-3, pressure relief valve 36 is actuated directly by the pressurized, molten resin 14 in the cavity mold 26. As indicated above, movable pin 42 in the pressure relief valve 36 shuts off the resin escape channel or second molten resin flow path 38 under a predetermined pressure and is held in place by the spring bias 44. When the cavity pressure exceeds the predetermined pressure limit the movable pin 42 pushes back against the spring bias 44 and allows the excess resin and pressure to escape the mold 24 through the second molten resin flow path 38 or escape channel. Not only does this vent the molten resin 14 out of the hollow 30, but it also reduces the pressure in the cavity mold 26 below the cavity mold failure point. After the part cures (cools) in the mold 24, the mold 24 opens and the part is ejected automatically. The molten resin 14 that flowed into the escape channel or second molten resin flow path 38 is ejected along with the part and the movable pin 42 resets itself automatically, shutting off the second molten resin flow path 38.

We have demonstrated that the test epoxy mold 24 can successfully vent excess molten resin pressure before the cavity mold 26 fails. We were able to accommodate different materials that require different pressures of cavity mold 26 by changing the spring bias 44 in the pressure relief valve 36 and/or adjusting the pre-load on the spring bias 44, as described.

An example of the process for selecting the proper strength spring bias 44 and pre-load adjustment for the cavity mold 26 and molten resin 14 is illustrated in Table 1. According to Table 1, the amount of pressure in the cavity mold 26 appeared fairly constant as a function of the spring bias 44 between minimum and maximum settings. Thus, one can select the appropriate spring type to enable ejection molding in the mold 24 at a certain pressure.

TABLE 1

| | | HOLD | | |
|---|---|---|---|---|
| | SETTING | PRESS? | | CAVITY |
| SPRING | MIN/MAX | YES/NO | PIN TRAVEL | PRESS. (psi) |
| Blue - LIGHT | Min | No | 0.060 | |
| | Half | Yes | 0.028 | 875 |
| | Max | Yes | 0.018 | 875 |
| Orange | Min | Yes | 0.050 | 1750 |
| | Half | Yes | 0.025 | 1750 |
| | Max | Yes | 0.015 | 1750 |
| Blue - HEAVY | Min | Yes | 0.025 | 2000 |
| | Half | Yes | 0.012 | 2000 |
| | Max | Unsafe | | |
| | | conditions | | |

PARTS LIST

| | |
|---|---|
| 10 | injection molding apparatus |
| 12 | injection molding machine |
| 14 | molten resin |
| 16 | screw cylinder |
| 17 | platen |
| 18 | tip |
| 20 | nozzle |
| 22 | screw |
| 24 | non-metallic injection mold |
| 26 | stationary cavity mold |
| 28 | movable core mold |
| 29 | ejector pins |
| 30 | hollow or first molten resin flow path |
| 35 | terminal end of the hollow 30 |
| 36 | pressure relief valve |
| 38 | second molten resin flow path |
| 42 | movable pin |
| 44 | spring bias |
| 45 | one end of pressure relief valve 36 |
| 46 | base plate |
| 48 | adjustment screw |
| 54 | parting line |

What is claimed is:

1. An injection molding apparatus, comprising:
an injection molding machine for injecting molten resin, said injection molding machine including a screw cylinder having a tip, a nozzle at said tip and a threaded screw advanceable in said screw cylinder for injecting molten resin from said nozzle;
a non-metallic injection mold comprising a cavity mold and a core mold forming a hollow therebetween for forming an injection molded product therein;
a first molten resin flow path extending from inside said screw cylinder to a terminal end of said hollow; and,
a pressure relief valve located on said first molten resin flow path at said terminal end of said hollow and adapted to release said molten resin from said first molten resin flow path at a pressure of said molten resin in said first molten resin flow path greater than a predetermined value.

2. The apparatus recited in claim 1 wherein said pressure relief value is adjustable for accommodating molten resin having a range of pressure and flow characteristics.

3. The apparatus recited in claim 1 wherein said non-metallic injection mold comprises cast epoxy and thermoset materials.

4. The apparatus recited in claim 1 wherein said pressure relief valve comprises a movable pin actuated by a spring bias, said movable pin being adapted for movement between a first position blocking said molten resin when said pressure is less than said predetermined value; and, to a second position releasing said molten resin in said first molten resin flow path into a second molten resin flow path in fluid communications with said first molten resin flow path thereby relieving pressure in said first molten resin flow path.

5. The apparatus recited in claim 1 wherein a stationary and a movable mold portion attached to said injection molding machine for accessing said cavity mold has a mold parting line, said mold parting line having said second molten resin flow path formed therein, whereby hardened resin in said second molten resin flow path is removed from the cavity mold with the molded part.

6. The apparatus recited in claim 5 wherein said pressure relief valve is mounted to one of said stationary and movable mold portions.

7. The apparatus recited in claim 1 wherein said non-metallic mold is made from a material selected from the group consisting of: a cast epoxy, stereo lithography, urethane, and silicone.

8. The apparatus recited in claim 4 wherein said pressure relief valve is adjustable to said predetermined value by adjusting a threaded screw supporting said spring bias biasing said movable pin.

9. The apparatus recited in claim 4 wherein said pressure relief valve is adjustable by changing said spring bias.

10. The apparatus recited in 1 wherein said pressure relief valve is adapted to automatically reset after said pressure in said first molten resin flow path falls below said predetermined value.
